(19) United States
(12) Patent Application Publication
(10) Pub. No.: US 2016/0019369 A1
(43) Pub. Date: Jan. 21, 2016

(54) SYSTEM AND METHOD FOR PRESCRIBING DIAGNOSTIC BASED THERAPEUTICS TO PATIENTS

(71) Applicant: T-VAK Industries LLC, Summit, NJ (US)

(72) Inventor: John Michael Williams, Short Hills, NJ (US)

(21) Appl. No.: 14/336,467

(22) Filed: Jul. 21, 2014

(51) Int. Cl. G06F 19/00; G06Q 50/22

(52) U.S. Cl. CPC G06F 19/3481; G06Q 50/22

(57) ABSTRACT

An exemplary computer implemented method for prescribing a therapeutic regimen is provided. The computer implemented method includes receiving, by one or more computing devices, prescription information for a patient. The prescription information includes information representing a medical condition diagnosed by a prescriber. An identifier or identifiers may be extracted from the prescription information. At least one identifier indicates a diagnosis associated with the diagnosed medical condition. Thereupon, virtual kit information from a virtual treatment kit having one or more updatable components may be identified from a database using the identifier. Each of the updatable components includes component information representing at least one predetermined medication and a treatment plan for administering the predetermined medication for treating the identified medical condition. At least part of the component information may be provided from the virtual treatment kit for distributing the medications and treatment plan to the patient.

### BACKGROUND

In recent years, demand for medical services is being outpaced by the number of specialists that can provide these services in a given field of medicine. For example, the number of dermatologists has steadily declined in comparison to other types of general practice physicians. In response to the shortage, there has been a proliferation of minute clinics and other types of non-specialist practices catering to various patient medical conditions. However, some of these practices are hiring non-physician clinicians to provide a greater number of patient services.

Often, the non-physician clinicians are the first to see a patient and may write prescriptions without consulting a physician. In many cases, the clinicians are not familiar nor “keep up” with optimal or effective therapeutic regimens for certain illnesses. In other cases, some patients may need a referral to a specialist for certain types of medical conditions, which can extend the patient's wait time for receiving effective treatment. Even further, incorrectly written prescriptions that fail to clearly identify medications or fail to give the patient important treatment information can lead to an increase in medical/prescription errors, thereby causing higher costs in delivering those medications as well as an overall cost of treatment for the patient.

### SUMMARY OF THE DISCLOSURE

Aspects of the disclosure may be advantageous for providing a computer implemented method for prescribing a therapeutic regimen. In one embodiment, the method includes receiving, by one or more computing devices, prescription information for a patient. The prescription information includes information representing a medical condition diagnosed by a prescriber. One or more identifiers may be extracted from the prescription information. At least one identifier indicates a diagnosis associated with the diagnosed medical condition. Thereupon, virtual kit information from a virtual treatment kit having one or more updatable components may be identified from a database using the identifier. Each of the updatable components includes component information representing at least one predetermined medication and a treatment plan for administering the predetermined medication for treating the identified medical condition. At least part of the component information may be provided from the virtual treatment kit for distributing the medication and treatment plan to the patient.

In one example, the method may include controlling the database for providing at least part of the component information from the virtual treatment kit. The component information may include an individual dosage amount and quantity for the predetermined medication.

In another example, the method may include generating the virtual treatment kit information to indicate at least one virtual treatment kit as the kit associated with a given diagnosis in the database. The virtual treatment kit information may be generated in accordance with approval information for the predetermined medication from an insurance provider. This approval information may be associated with information in the database indicating the virtual treatment kit. The virtual treatment kit information may be generated by substituting at least one component of the one or more updatable components of the virtual treatment kit with information regarding a different medication and/or by substituting at least one component of the one or more updatable components of the virtual treatment kit with information regarding a different treatment plan.

In yet another example, the method may include determining occurrence information for a given medical condition based on at least the identifier in the database indicating a diagnosis for the given medical condition and a location at which the virtual treatment kit associated with the diagnosis is prescribed and/or dispensed. The determined occurrence information may indicate a prevalence of the given medical condition within a given area approximate to the location such that an outbreak in the area can be detected.

In another embodiment, a non-transitory computer readable medium is provided. The non-transitory computer readable medium storing instructions that, when executed by one or more processors, cause the one or more processors to perform a method for prescribing a therapeutic regimen. The method includes receiving, by one or more computing devices, prescription information for a patient. The prescription information includes information representing a medical condition diagnosed by a prescriber. One or more identifiers may be extracted from the prescription information. At least one identifier indicates a diagnosis associated with the diagnosed medical condition. Thereupon, virtual kit information from a virtual treatment kit having one or more updatable components may be identified from a database using the identifier. Each of the updatable components includes component information representing at least one predetermined medication and a treatment plan for administering the predetermined medication for treating the identified medical condition. At least part of the component information may be provided from the virtual treatment kit for distributing the medication and treatment plan to the patient.

In yet another embodiment, a system is provided. The system includes a memory storing a plurality of virtual treatment kits and one or more processors in communication with the memory. The one or more processors are configured to receive prescription information for a patient. The prescription information includes information representing a medical condition diagnosed by a prescriber. One or more identifiers may be extracted from the prescription information. At least one identifier indicates a diagnosis associated with the diagnosed medical condition. Thereupon, virtual kit information from a virtual treatment kit having one or more updatable components may be identified from a database using the identifier. Each of the updatable components includes component information representing at least one predetermined medication and a treatment plan for administering the predetermined medication for treating the identified medical condition. At least part of the component information may be provided from the virtual treatment kit for distributing the medication and treatment plan to the patient.

### BRIEF DESCRIPTION OF THE DRAWINGS

FIG. 1 is an illustration of a prescription transmittal process in accordance with aspects of the disclosure.

FIG. 2 is a pictorial diagram of a system in accordance with aspects of the disclosure.

FIG. 3 is a block diagram of a system in accordance with aspects of the disclosure.

FIG. 4 is an illustration of a process for processing a prescription request in accordance with aspects of the disclosure.

FIG. 5 is an illustration of a virtual treatment kit in accordance with aspects of the disclosure.

FIG. 6 is an illustration of another virtual treatment kit in accordance with aspects of the disclosure.

FIG. 7 is an illustration of a system of communication of diagnostic, medical and therapeutic information over a network in accordance with aspects of the disclosure.

FIG. 8 is a flow diagram depicting an example of a method in accordance with aspects of the disclosure.

### DETAILED DESCRIPTION

The present disclosure generally relates to providing a system for prescribing diagnostic based therapeutic regimens to patients. This may allow the patient to receive selected medications for treating a medical condition diagnosed by a prescriber. One aspect of the system includes a communication system for communicating, with a pharmacist, pharmacy tech, or other individuals able to fill and dispense prescriptions (e.g., dispensing physicians). The system may be used to communicate specific treatment information indicating a specific treatment to dispense to the patient based on a diagnosed medical condition with specific instructions assigned to the treatment dispensed. Because of the communication of the specific treatment information, the licensed prescriber need not transmit such information as specific drugs names, (brand or generic), strengths, doses, amounts and instructions for the pharmacist to decipher.

In some embodiments, the system may receive a diagnostic-based prescription that includes prescription information for the patient. A “patient” may refer to a human customer who is seeking treatment for a medical condition. In some embodiments, the techniques described herein may be beneficial for treating other types of patients, such as dogs, cats, horses and other types of animal patients that require veterinary medicine treatment. In that regard, the prescription information may be related to the medical condition of the patient. For example, the prescription information may include information pertaining to a certain medical condition, such as a dermatological condition, of the patient caused by some kind of illness, such as a type of skin disease. Alternatively, other types of medical diagnoses caused by different kinds of medical conditions may be referred to in the diagnostic-based prescription.

A prescriber may have rendered the medical diagnosis related to the patient's medical condition. Although these types of prescribers may be doctors, e.g., family or general physicians, they do not have to be doctors or specialists in a field of medicine in order to utilize features of the disclosure described herein. Once the prescriber has rendered the diagnosis of the patient, the diagnostic-based prescription may be transmitted, such as in an electronic transmission, paper prescription or by various other types of transmission techniques.

To ascertain the medical condition of the patient, an identifier related to the medical condition may be extracted from the prescription information included therein. For example, the prescription information may include a predetermined identifier indicating the prescription type (e.g., DBRx) and a medical diagnostic identifier for the diagnosed medical condition (e.g., Poison Ivy). Thus, the combination of these two pieces of information may alert the system to recognize that the diagnostic-based prescription is received on behalf of the patient.

A virtual treatment kit that includes one or more updatable components may be identified by the system from a database using the identifiers. Each of the updatable components of a given virtual treatment kit includes component information that represents one or more predetermined medication(s) and a treatment plan or schedule for the patient on how and when to administer the predetermined medications in order to treat the diagnosed medical condition. At least a part of this information from the virtual treatment kit may be then provided to the patient by the pharmacist that may have read the information, for example, off of a print out or on a user-interface display of the system.

In one embodiment, an insurance provider associated with the patient may provide approval for the medications in the virtual treatment kits. In some embodiments, some component of the one or more components of the virtual kits may be substituted for a different medication/dosage amount and/or a different treatment plan. In other embodiments, a location of where certain virtual treatment kits are dispensed may be used as a type of indicator, for example, as an outbreak indicator of a given medical condition occurring near that location.

For a circumstance in which the subject matter disclosed herein collects data regarding distribution of virtual treatment kits, this data need not include any identifying information regarding the patient, but only that necessary to identify an individual virtual kit associated with a certain medical condition and the location at which the kit is distributed. It should be understood that data collected in accordance with this disclosure may be limited to the information discussed above and need not contain additional information. For example, information regarding the identity of the patient, such as patient's name or identifying information need not be collected, and in fact, this type of personal information may actually be removed in order to protect the patient's privacy.

Aspects, features and advantages of the disclosure will be appreciated when considered with reference to the following description of embodiments and accompanying figures. The same reference numbers in different drawings may identify the same or similar elements. Furthermore, the following description is not limiting; the scope of the present technology is defined by the appended claims and equivalents. While certain processes in accordance with example embodiments are shown in the figures as occurring in a linear fashion, this is not a requirement unless expressly stated herein. Different processes may be performed in a different order or concurrently. Steps may also be added or omitted unless otherwise stated.

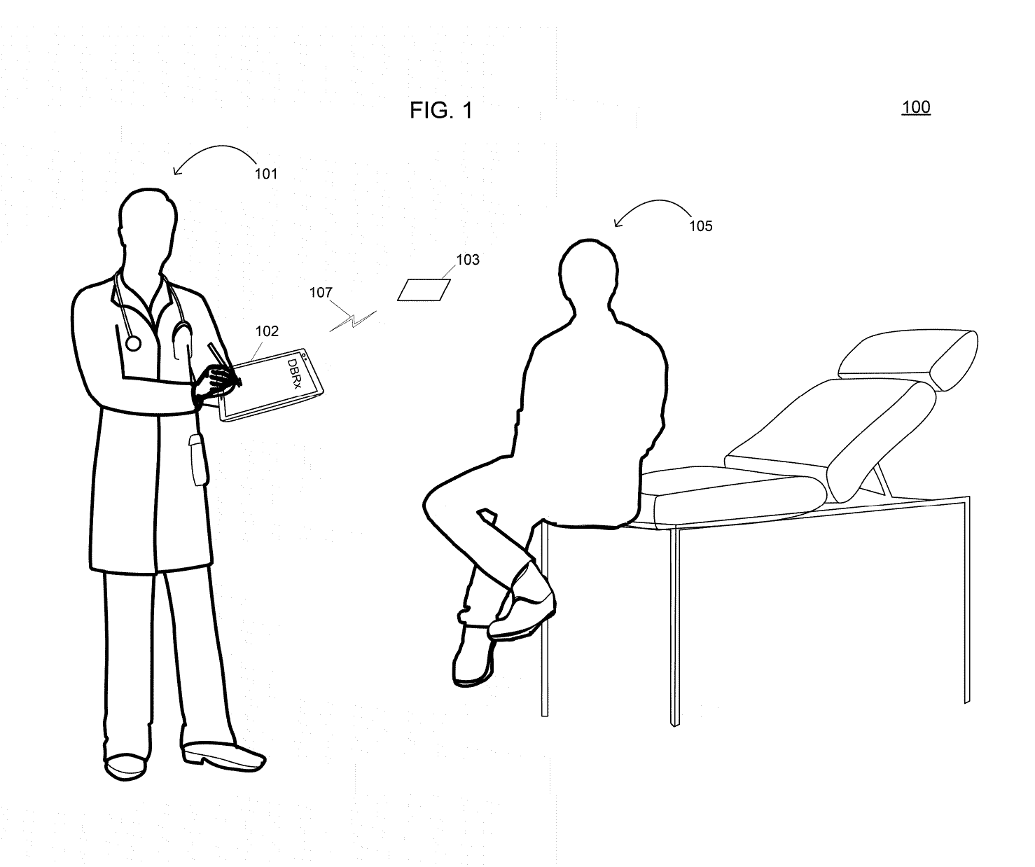

FIG. 1 is an illustration of a prescription transmittal process 100 in accordance with aspects of the present disclosure. This example should not be considered as limiting the scope of the disclosure or usefulness of the features described herein. For example, the techniques described herein can be employed using traditional prescription forms or other methods of transmitting prescriptions for patients. In this example, a prescriber 101 using a client device 102 may submit a prescription request 103 for patient 105 via communication channel 107. For example, as a result of a health check visit for the patient 105, the prescriber 101 may have diagnosed that the patient 105 suffers from a certain medical condition. As discussed above, the prescriber 101 does not have to be a doctor or medical specialist. Rather, the prescriber 101 may be a registered nurse practitioner, physician assistant, clinician or other type of prescriber that can write prescriptions for treating the diagnosed medical condition.

Prescriber 101 may submit the prescription request 103 using various techniques. By way of example only, client device 102 may electronically transmit the prescription request 103 via communication channel 107 from a first location, such as the prescriber's office, to a second location, such as a pharmacy selected by the patient. For example, communication channel 107 may include a wireless or wired network connection for transmitting data between the client device 102 and a back office server of the pharmacy. The request 103 desirably is transmitted with location information indicating geographic location, for example, of an origination location for the request 103. In some embodiments, the client device 102 transmitting request 103 may generate the location information using GPS or other types of positioning systems. In other examples, the prescription request 103 may be transmitted in hard copy form. For example, the prescription request 103 may be hand written, transmitted to a printer, copier or fax machine or by other means for creating a hard copy of the prescription request 103 depending upon the needs of the prescriber, patient, and pharmacy.

So that the prescription request 103 can be processed, for example, at a given pharmacy, the prescriber 101 may inscribe or otherwise include thereon, using the client device 102, one or more identifiers. For example, the prescriber 101 may inscribe a prescription identifier on the prescription request 103 to indicate to the receiver that this request is of a particular type of prescription, such as a diagnostic-based prescription. As discussed above, the prescription identifier for the diagnostic-based prescription may be used to identify a virtual treatment kit that includes a treatment regimen for treating the patient. For example, the treatment regimen associated with a given virtual treatment kit may include an effective predetermined combination or single type of medication for treating a specific medical condition.

In one example, the prescription identifier for a diagnostic-based prescription on the prescription request 103 may include at least two entries. By way of example only, a first entry of the prescription identifier may include a certain class identifier, such as DBRx, to identify that this prescription request 103 may be associated with the virtual treatment kit/treatment regimen tailored to the diagnosed medical condition of the patient 105.

A second entry on the prescription request 103 represents a medical diagnostic identifier. For example, the medical diagnostic identifier may be used to identify a specific medical condition associated with the diagnosis of the patient 105. This diagnostic identifier may include a predetermined code or other types of information to identify the specific type of medical condition, such as poison ivy, which may be the cause of the patient's symptoms. In some embodiments, the second entry representing the diagnostic identifier may be chosen from a drop-down menu/list displayed on client device 102. The drop-down list may contain a plurality of diagnostic choices for providing the prescriber 101 with quick and efficient access to all of the possible diagnostic identifiers available for the diagnostic-based prescription.

An advantage of using diagnostic-based prescriptions is that it allows prescriber 101 to prescribe an effective treatment for the patient's condition without having to be updated on the latest medications that can be used for that condition. For example, although treatment regimens associated with the virtual kits may change overtime, the diagnostic identifiers for these virtual kits can remain constant. In addition, the diagnostic-based prescriptions eliminate the need for confusing drug and dosage abbreviations used by many prescribers, which can be a source of many medication errors when prescription requests are submitted and later processed.

In some aspects, the prescriber 101 may utilize an application for submitting the prescription request 103. Aspects of the application may be installed locally at the client device 102. Alternatively, the application can be stored at a remote server and may be accessed using the client device 102, for example, via a web interface. In some embodiments, the application may transmit the prescription request 103 for further processing.

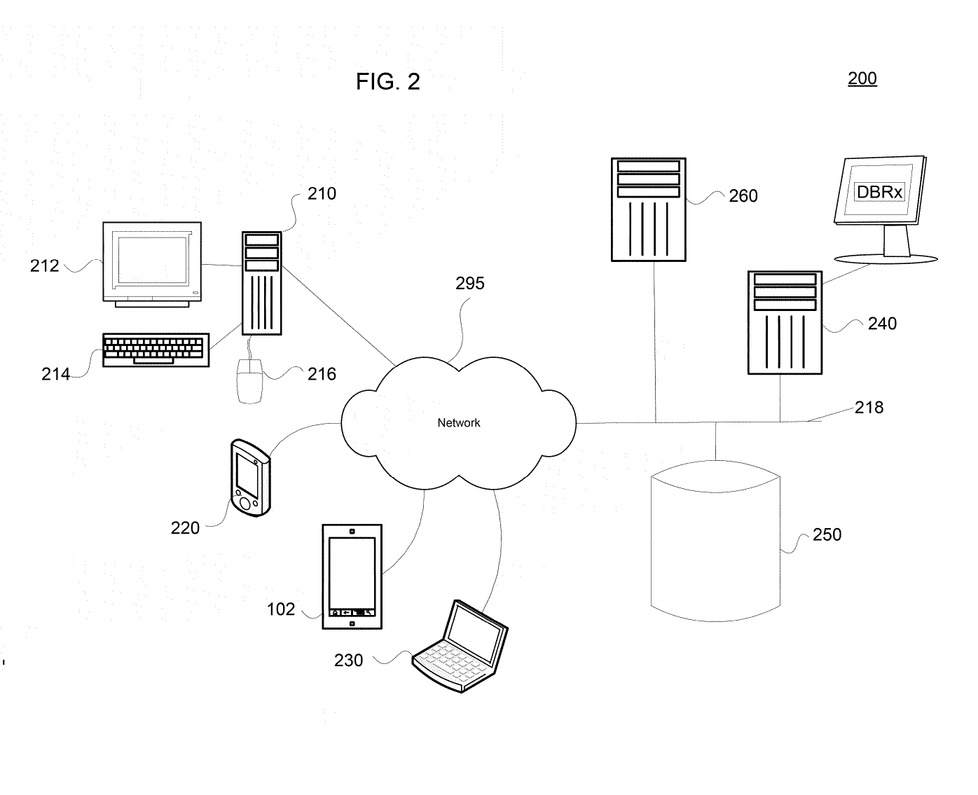

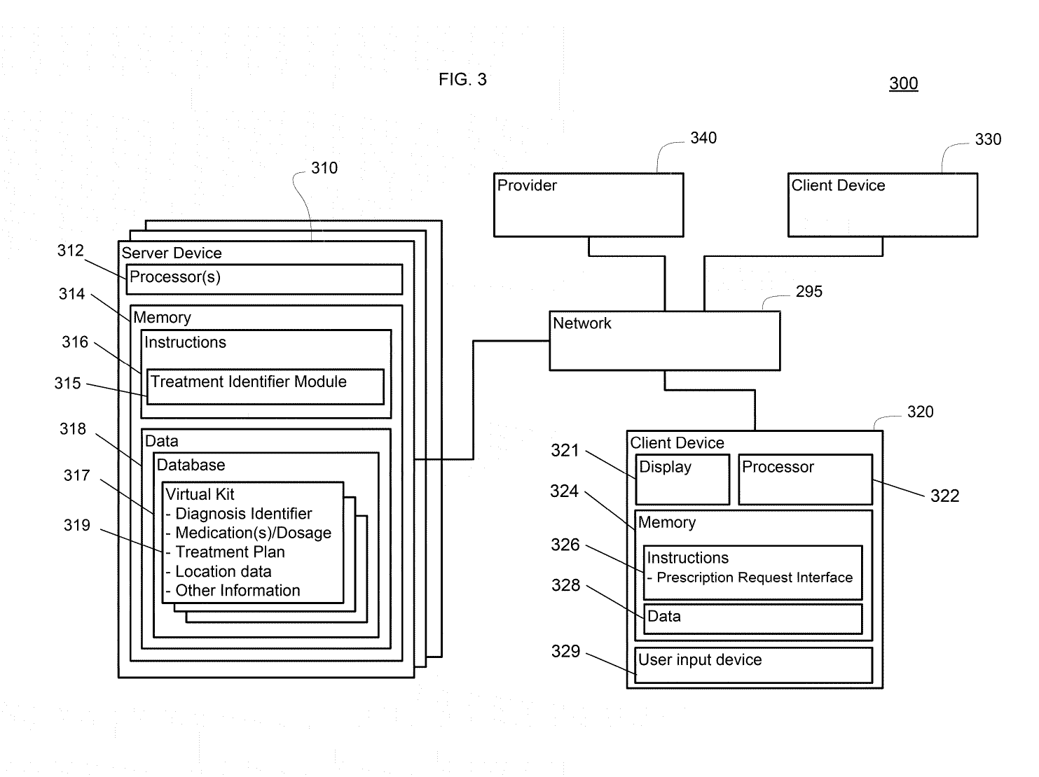

While it can be possible to perform aspects of the techniques described herein with an application installed on client device 102 at a standalone location, such as on a tablet device within a clinic facility that can dispense medications, it may also be feasible to do some processing at remotely dispersed locations as well as locally (or some combination thereof). For instance, a remote server of a system (e.g., a system of a pharmacy chain) may perform some or all aspects of the prescription processing for distributing virtual kits to patients. Examples of these types of systems are in further detail below with respect to FIGS. 2 and 3.

### Example Systems

FIG. 2 is a pictorial diagram of a system 200, which may be used to implement aspects of the present invention as described herein. As shown, system 200 depicts various devices that can be used alone or in a networked configuration. For example, this figure illustrates a computer network having a plurality of computing devices 240 and 260, e.g., computing devices located at a number of different pharmacy locations, as well as client device 102 and other types of computing devices, such as computer terminal 210, PDA 220 and laptop/netbook 230. These various devices may be interconnected via a local bus or direct connection 218 and/or may be coupled via a communications network 295 such as a LAN, WAN, the Internet, etc. and which may be wired or wireless.

Each device may include, for example, user input devices such as a keyboard 214 and mouse 216 and/or various other types of input devices such as pen-inputs, joysticks, buttons, touch screens, etc., as well as a display 212, which could include, for instance, a CRT, LCD, plasma screen monitor, TV, projector, etc. Each device may be a personal computer, application server, etc. By way of example only, computing device 240 may be a personal computer while computing device 260 may be a server. Databases, such as database 250, may be accessible to one or more of the computing devices or other devices of system 200.

In FIG. 3, a block diagram of a system 300, such as a system of a pharmacy, is depicted. As shown, the system 300 includes one or more computing devices like any of the devices of FIG. 2. For example, computing devices include a plurality of servers, such as server device 310, coupled to network 295 and a number of client devices 320 and 330 that are capable of communicating with the servers over the network 295. Server device 310 may include one or more processors 312, memory 314, and other components typically present in general purpose computers. Each processor of the one or more processors 312 may be a conventional processor, such as a processor found in commercially available computers. Alternatively, each processor may be a dedicated controller, such as an ASIC, FPGA or other hardware-based processors.

Memory 314 may store information that is accessible by the processors 312, including instructions 316 that may be executed by the processors 312, and data 318. The memory 314 may be of a type of memory including a non-transitory computer-readable medium, or other medium that stores data that may be read with the aid of an electronic device, such as a hard-drive, memory card, read-only memory (“ROM”), random access memory (“RAM”), digital versatile disc (“DVD”) or other optical disks, as well as other write-capable and read-only memories. The subject matter disclosed herein may include different combinations of the foregoing, whereby different portions of the instructions 316 and data 318 are stored on different types of media.

Although FIG. 3 functionally illustrates the processors 312 and memory 314 as being within the same block, the processors 312 and memory 314 may actually include multiple processors and memories that may or may not be stored within the same physical housing. For example, some of the instructions 316 and data 318 may be stored on removable CD-ROM and others within a read-only computer chip. Some or all of the instructions 316 and data 318 may be stored in a location physically remote from, yet still accessible by, the processors 312. Similarly, the processors 312 may actually comprise a collection of processors, which may or may not operate in parallel.

Data 318 may be retrieved, stored or modified by processors 312 in accordance with the instructions 316. For instance, although the present disclosure is not limited by a particular data structure, the data 318 may be stored in computer registers, in a relational database as a table having a plurality of different fields and records, XML documents, or flat files. The data 318 may also be formatted in a computer-readable format such as, but not limited to, binary values, ASCII or Unicode. By further way of example only, the data 318 may comprise information sufficient to identify the relevant information, such as numbers, descriptive text, proprietary codes, pointers, references to data stored in memory or information that is used by a function to calculate the relevant data. For example, the data 318 may include a database 317 comprising one or more virtual kits 319, which may include information relevant to identify an individual virtual kit from the database 317.

Database 317 of server 310 may store information regarding the virtual kits 319 that includes information representing one or more updatable components. Each virtual kit 319 may be associated with a diagnostic identifier for identifying at least one virtual treatment kit as the kit for a given medical diagnosis in the database 317. Virtual treatment kits 319 from database 317 may be used to identify an effective treatment regimen for treatment of the given medical diagnosis. Each virtual treatment kit can include information regarding each kit component, such as particular medications including an individual dosage amount for each medication, a treatment plan for administering the medications, location data associated with a location of where the virtual treatment kits 319 are prescribed and/or distributed and other information that may be useful for identifying and distributing the virtual kits 319 to patients, such as bar codes, QR codes or other types of machine-readable label identifier information.

In some embodiments, the database 317 may be separate components from server 310. Alternatively, the database 317 may be internally included with the server 310. For example, as shown, the database 317 may be in the memory 314 of server 310. In other embodiments, the database 317 can be divided into multiple databases with components that can be geographically dispersed, for example, at different pharmacy locations.

To establish the database 317, virtual treatment kit information may be generated regarding the identity and/or approval of components in the virtual kits 319, for example, through a provider 340, such as an insurance provider or insurer. As shown in FIG. 3, the insurance provider 340 may be accessible via the network 295. Information from the provider 340 may be used to approve information for the medications associated with an individual virtual treatment kit contained in the databases 317. In some embodiments, the virtual kit components can be selected based on certain information regarding current evidence-based medicine, efficacy, safety, licensing agreements, cost factors, and judgment of physicians, pharmacists and/or other experts in the diagnosis and treatment of disease and preservation of health.

In addition, the virtual kit components can be selected based on an insurer's particular formularies, which can vary between insurers and are regularly updated. A “formulary” is a list of medications/prescription drugs available to enrollees of a healthcare plan. Many formularies are “tiered” to provide financial incentives to patients to select lower cost medications. For instance, “tier 1” medications are typically generic medications with the lowest co-pay amounts/co-insurance. “Tier 2” medications are typically “preferred” brand name medications with higher co-pay amounts/co-insurance. “Tier 3” medications are typically “non-preferred” brand name medications with the highest co-pay amounts/co-insurance. For virtual kit medications not on an insurer's formulary, the patients may have to pay 100% of the cost of the medications. In this regard, it should be noted that the medications used for the virtual treatment kits 319 may have already been approved and be on the formularies of many health care plans. In some aspects, however, insurer approval may not be required for the patient to receive the benefits of the techniques described herein. For instance, if a virtual treatment kit 319 contains two medications and medication 1 is a tier 1 medication and medication 2 is a medication of tier 2, a patient would pay the respective co-pay amounts/co-insurance for these two medications. In other aspects, insurers may approve/permit the distribution of virtual treatment kits with a single co-pay/co-insurance per kit, even if multiple medications are distributed.

Server 310 may be at one node of network 295 and capable of directly and indirectly communicating with other nodes of the network 295. For example, the server 310 may include a web server that may be capable of communicating with client devices 320 and 330 via network 295 such that it uses the network 295 to transmit and display information to a user on a display 321 of the client device 320 and/or client device 330. The server 310 may also include a plurality of computers that exchange information with different nodes of a network for the purpose of receiving, processing and transmitting data to the client devices. In this instance, the client devices, such as client devices 320 and 330 will typically still be at different nodes of the network 295 than the computers comprising server 310.

Network 295, and intervening nodes, may include various configurations and protocols including the Internet, World Wide Web, intranets, virtual private networks, wide area networks, local networks, private networks using communication protocols proprietary to one or more companies, Ethernet, WiFi (e.g., 802.11, 802.11b, g, n, or other such standards), HTTP, and various combinations of the foregoing. Such communication may be facilitated by a device or devices capable of transmitting data to and from other computers, such as modems (e.g., dial-up, cable or fiber optic) and wireless interfaces.

Although certain advantages are obtained when information is transmitted or received as noted above, other aspects of the subject matter disclosed herein are not limited to a particular manner of transmission of information. For example, in some aspects, information may be sent via a medium such as a disk, tape or CD ROM. Yet further, although some functions are indicated as taking place on a single server having a single processor, various aspects may be implemented by a plurality of servers, for example, communicating information to client devices 320 and 330 over network 295.

Each client device 320 and 330 may be configured similarly to the server 310, with a processor 322, memory 324, instructions 326, data 328 and all of the internal components normally found in a personal computer. By way of example only, the client device 320 may include a central processing unit (CPU), such as processor 322, display device 321 (for example, a monitor having a screen, a projector, a touch-screen, a small LCD screen, a television, or another device such as an electrical device that is operable to display information processed by the processor 322), CD-ROM, hard-drive, user input 329 such as a keyboard, mouse, touch-screen or microphone, speakers, modem and/or network interface device (telephone, cable or otherwise) and all of the components used for connecting these elements to one another.

By way of example only, client devices 320 and 330 may be a computing device, such as a laptop computer, a netbook, a desktop computer, and a portable personal computer such as a wireless-enabled PDA, a tablet PC or another type of computing device capable of obtaining information via a network like the Internet. Although the client device 320 may include a full-sized personal computer, the subject matter of the present disclosure may also be used in connection with mobile devices capable of wirelessly exchanging data. For example, client device 320 may be a wireless-enabled device, such as a tablet computer, or an Internet-capable mobile device. In either regard, information may be inputted by using a small keyboard, a keypad, a touch screen, light pen or other means of user input. In various aspects, the client devices and computers described herein may comprise a device capable of processing instructions and transmitting data to and from humans and other devices and computers.

Instructions 316 and 326 of the server 310 and client device 320 respectively may be a set of instructions to be executed directly (such as machine code) or indirectly (such as scripts) by the processor. In that regard, the terms “instructions,” “steps” and “programs” may be used interchangeably herein. The instructions 316 and 326 may be stored in object code format for direct processing by the processor, or in another computer language including scripts or collections of independent source code modules that are interpreted on demand or compiled in advance. Processes, methods and routines of the instructions are explained in more detail below.

The instructions 326 of client device 320 may include a prescription request interface for entering and/or receiving a prescription request. By way of example only, patient requests for prescriptions can be made through the prescription request interface and transmitted electronically to server 310 for processing. For example, after entering the prescription request into the prescription request interface, the request may be transmitted to server 310 via network 295. The prescription request interface provides for the display of information by sending and receiving information/data across the network 295. In some examples, the prescription request interface can be used for receiving a “copy” of information or requesting refills of the virtual kits 319 or for seeking/receiving information about a medical diagnosis associated with the virtual kits 319 or for seeking/receiving offers from third parties regarding the diagnosis.

In response to receiving information from the prescription request interface, certain database information may be accessed and/or stored in database 317. For example, this may include accessing from the database 317 component information regarding the virtual treatment kits and in turn storing location information in the database 317 regarding a location of where the virtual kits for a given medical condition have been prescribed and/or distributed.

In order to facilitate operations of system 300 for processing a diagnostic-based prescription transcription request, the server 310 may further include a treatment identifier module 315 that may be used to extract medical diagnostic identifiers from the request. For example, treatment identifier module 315 may detect (e.g., using character recognition techniques) that the request includes certain codes indicating that a diagnostic-based prescription request is received. In response, one or more identifiers may be pared out from the request by the module 315. The identifiers may be used to identify a corresponding virtual treatment kit 319 from database 317 for treating the medical diagnosis. In some embodiments, the functionality of this module can exist in a fewer or greater number of modules than what is shown, with such modules residing at one or more computing devices that may be geographically dispersed. The modules may be operable in conjunction with client devices 320 and 330 and/or provider 340 from which it may receive and provide relevant information (e.g., virtual kit information) regarding prescription requests.

### Example Methods

Techniques for processing a diagnostic-based prescription request for distributing a virtual treatment kit to a patient, for example, using system 300 as discussed above, will now be described. As previously discussed, the following operations do not have to be performed in the precise order described below. Rather, as mentioned above, various operations can be handled in a different order or simultaneously, and operations may be added or omitted.

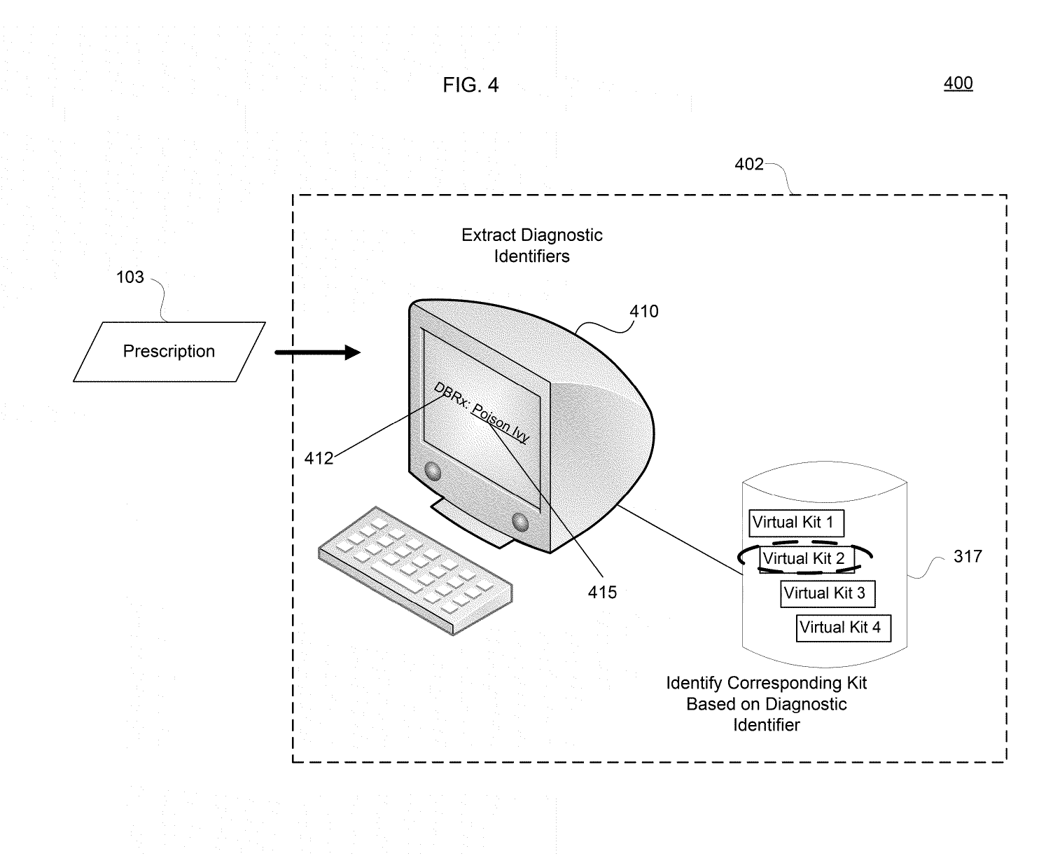

FIG. 4 is an illustration of a process 400 for processing a prescription request, such as the diagnostic-based prescription request 103 from FIG. 1. For example, the request 103 may be processed, e.g., at a pharmacy 402 having a system similar to system 300, for distributing information as well as medications to patients regarding an appropriate virtual treatment kit for their diagnosed medical condition. In this example, the pharmacy 402 may include a computing server device 410 that is in communication with database 317 for receiving and sending information regarding the virtual treatment kits. As discussed above, the prescription request 103 may be transmitted from a prescriber's client device, such as device 102, to the computing server device 410 using, for example, a wireless or wired connection. Alternatively, if the prescription request 103 is received in hard copy form, it may be entered in the computing server device 410, for example, by using an input device and display connected to the computing server device 410.

Once the diagnostic-based prescription request 103 is received, one or more identifiers may be extracted. As discussed above, the identifiers may include entries for a prescription identifier 412 to indicate that the request 103 is a diagnostic-based prescription request, and a medical diagnostic identifier 415 to identify a specific medical condition associated with the request. Database 317 as described in FIG. 3, may be searched using this medical diagnostic identifier 415 to identify a corresponding virtual treatment kit for treating the patient. For example, as shown in FIG. 4, virtual treatment kit 2 from database 317 may be identified as the kit needed to treat the medical condition “Poison Ivy.”

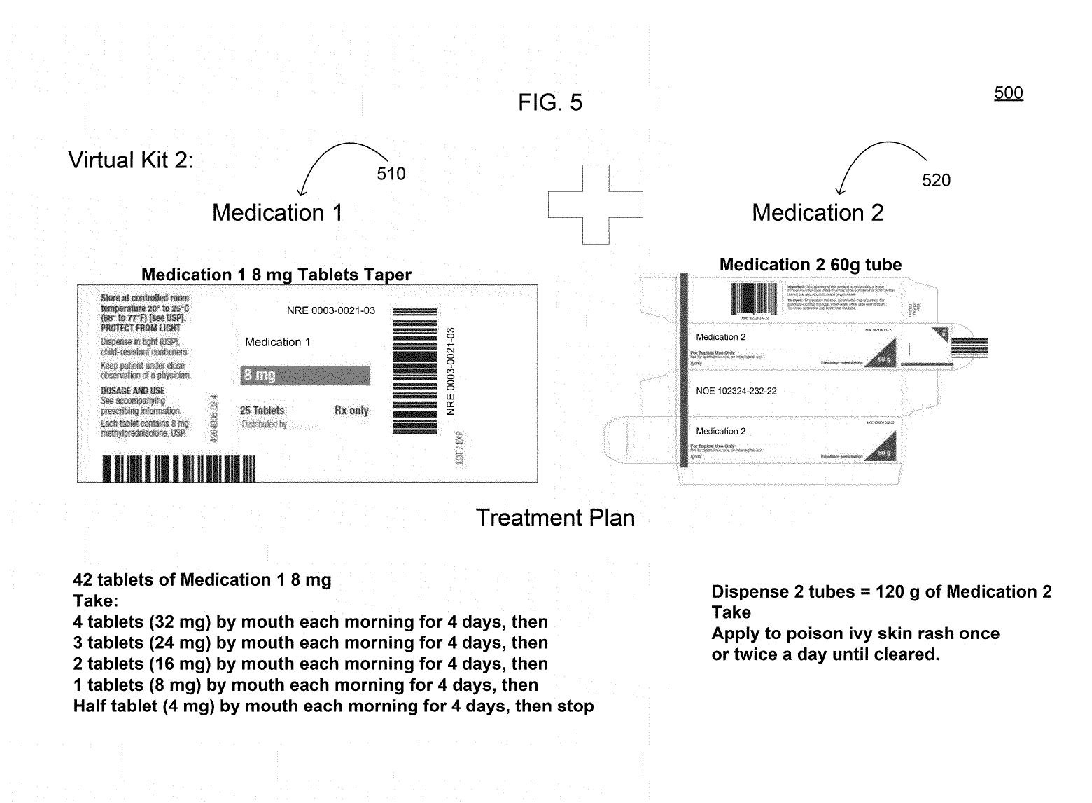

Turning to FIG. 5, an illustration of a virtual treatment kit 500 is shown, such as virtual treatment kit 2 from FIG. 4. As discussed above with regard to system 300 of FIG. 3, each virtual treatment kit includes component information regarding one or more components that includes medication information and a treatment plan for taking, injecting, applying, or other means of administration of the medication to a given patient. In this example, virtual treatment kit 500 includes information regarding at least two medications 510 and 520. For example, medication 510 may be an oral medication while medication 520 may be a topical medication for applying to the patient's skin. This virtual treatment kit 500 indicates that the combination of the two medications 510 and 520 may be an effective treatment for the medical condition associated with this kit. For example, the treatment plan for virtual treatment kit 500 includes information on the quantity of each medication in the kit to be dispensed, an individual dosage amount for each medication to be used as well as when and how much of that medication should be taken or applied for treating the patient.

In some embodiments, the virtual treatment kit 500 can also include other information, such as an indication of time period in which the medical condition associated with the patients may be expected to improve. If the medical condition fails to improve within this time period, the patients may also receive information indicating that patients should seek a referral to a specialist for their medical condition.

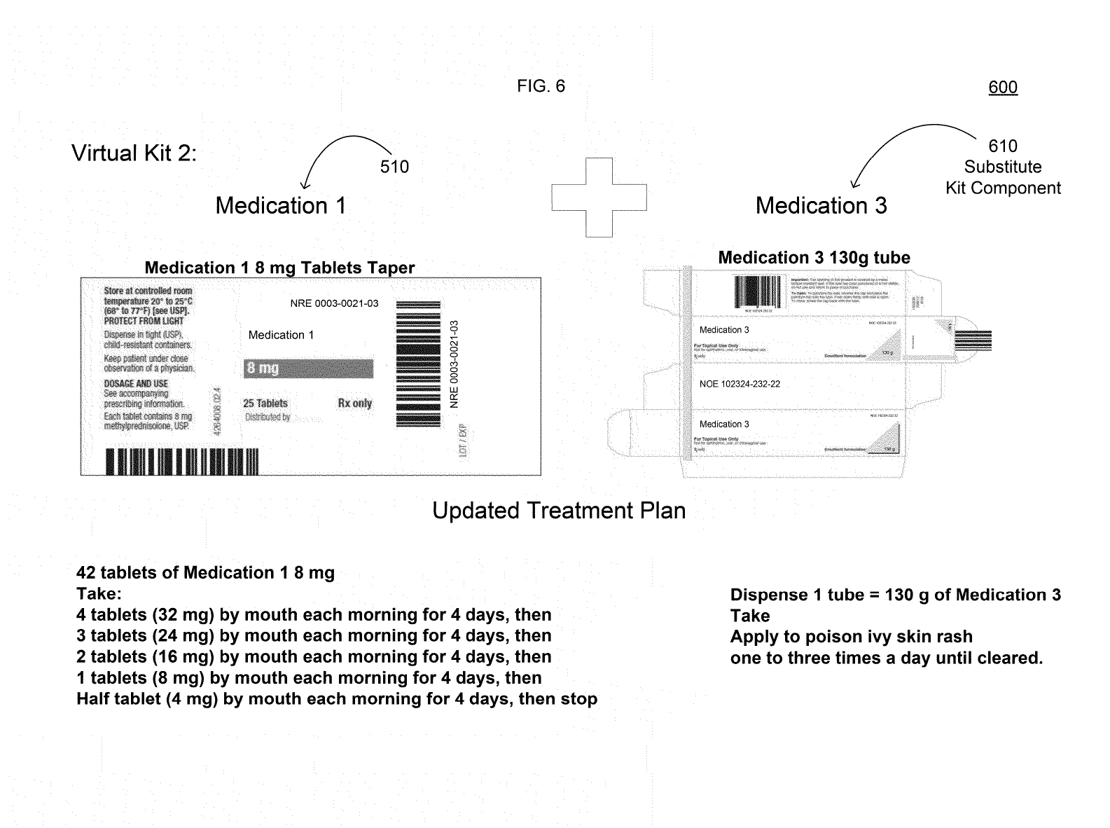

In FIG. 6, another virtual treatment kit 600 is shown. Components of one virtual treatment kit for one medical condition (e.g., “Poison Ivy”) may be identical to the components of another virtual treatment kit (e.g., “Drug Rash”). In some situations, one or more components of a kit may be replaced with substitute components. For example, as shown in FIG. 6, medication 610 and a new treatment plan are used as substitutes for previous components in this virtual treatment kit 600 (e.g., virtual treatment kit 2). There are many situations in which this type of substitution of kit components can occur. For example, in some situations certain medications may be replaced by generic or brand versions of the medications, or the medications may be substituted with newer effective medications and/or treatment plans. In other situations, the medications may be substituted based on current research and/or pre-approved licensing agreements for the medications, or many other situations for replacing the virtual kit components may apply. In other embodiments, medication components of the virtual kits may be substituted based on provider/insurer information, such as the type of provider/insurer for the patient and certain insurer formularies.

In some embodiments, the quantity and dosage of medications associated with the virtual kits can also be changed based on additional indicators (e.g., weight, body mass index, age of patient). For example, if a patient is beyond some weight threshold, the virtual kit medications for their medical condition may be adjusted to account for the patient's weight. In this example, the patient may receive the same virtual kit components, but the medications may be increased or decreased from a “standard/default” quantity or schedule.

As noted above, an advantage of the present disclosure is that no matter how many times components of the virtual treatment kits are substituted or otherwise replaced, the medical diagnostic identifiers for these kits can still remain the same. This allows prescribers to prescribe an effective treatment kit/plan for the patient's medical conditions without having to remain current with any changes to the kit/plan components or to effective treatments for the patient's medical conditions. This is particularly advantageous when the prescriber is not a physician or a specialist, but rather a general clinician.

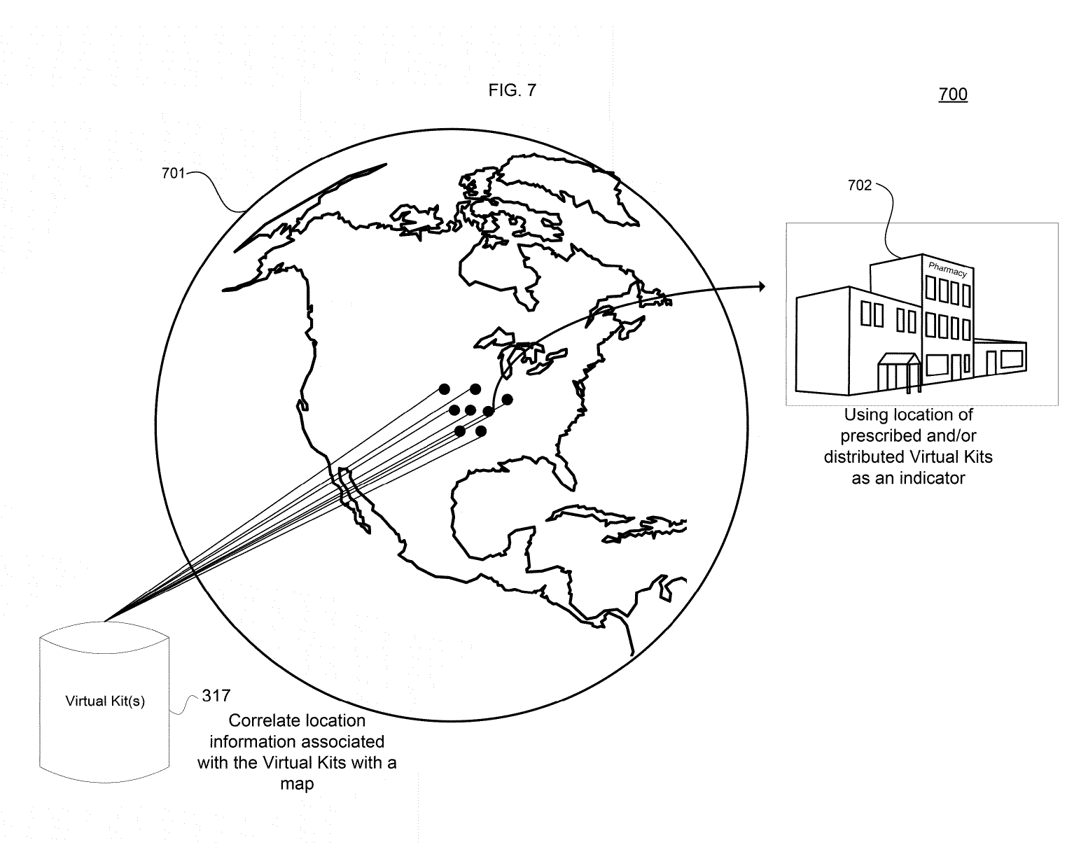

FIG. 7 is an illustration of a system of communication of diagnostic, medical and therapeutic information over a network 700. As shown, the system 700 may facilitate communication of information regarding the prescribing and/or distribution of virtual treatment kits for a particular medical condition among a plurality of locations, such as location 702. For example, the plurality of locations may include pharmacies, drugstores, hospitals, clinics, or other types of treatment centers capable of prescribing and/or distributing medications associated with the virtual treatment kits.

An epidemiological data history of which kits have been prescribed and/or distributed at these locations can be correlated by the system 700 from a number of virtual kit databases, such as databases 317 as described above, and the system 700 may then control display of such information on a map 701, to indicate the geographic locations at which point the kits have been prescribed and/or distributed. In this regard, each bullet point on map 701 may indicate a number of virtual kits prescribed and/or distributed for a particular medical condition within a given area proximate to or at a location on the map 701. If the number of kits for the particular medical condition exceeds a threshold level, this can indicate that there may be an occurrence of disease outbreak nearby for the particular medical condition. When the threshold level is reached, the system 700 may render an indication such as visually on the map 701 with emphasis or the like, audibly or by electronic messaging over a communication network.

An advantage of the epidemiological data history gathered based on the virtual kits is that it can be used to indicate a highest and lowest concentration of a certain disease in a given local (town, county, state, geographic region, country, continent, etc.). This may enable physicians, health departments, governments, pharmaceutical companies, marketers, insurers, etc., to concentrate their efforts regarding particular diseases to those areas where the diseases may be prevalent. In addition, the techniques described herein may enable insurers to track costs more accurately and/or effectively with respect to their insured populations. For instance, insurers can track whether there are more or less referrals to specialists for patients receiving virtual kits over traditional prescriptions, whether the yearly drug costs for patients receiving virtual kits are more or less than insured patients not receiving the kits, and whether the kits are effective in treating the patient's condition. For example, patients receiving the virtual kits can answer surveys or “rate” the kits after using them via a client device (e.g., PDA, computer, etc.).

As discussed above, data collected regarding the distribution of virtual treatment kits need not include any identifying information regarding a given patient. Moreover, certain data may also be treated in one or more ways before it is stored or used, so that no personally identifiable information can be determined.

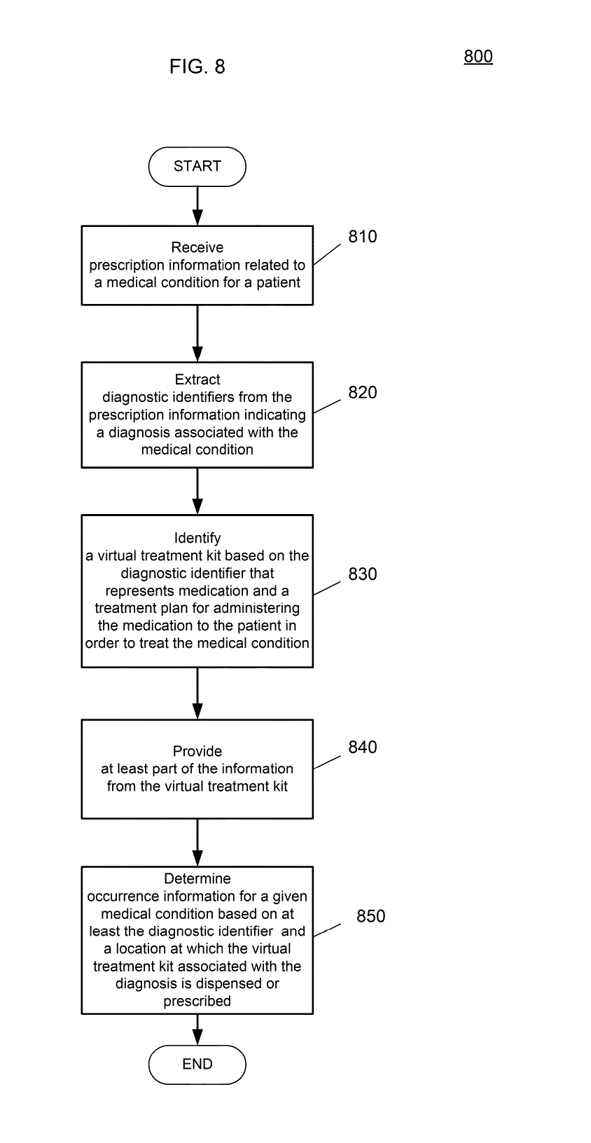

To better aid in understanding an example of some of the aspects described above, reference is now made to FIG. 8, which is a flow diagram 800. At stage 810, prescription information related to a medical condition for a patient may be received. For example, the prescription information may include a diagnostic-based prescription request transmitted from a prescriber that has diagnosed the patient's medical condition. In some embodiments, this request may be received at a computing device associated with a system (e.g., a pharmacy system) for processing and fulfillment of the received request.

At stage 820, a diagnostic identifier may be extracted from the prescription information. For example, a number of identifiers may be parsed from prescription information. In this regard, the prescription information may include at least one diagnostic identifier associated with the diagnosed medical condition of the patient.

At stage 830, a virtual treatment kit may be identified based on the diagnostic identifier. For example, the virtual treatment kit may be identified from a database associated with the system using the diagnostic identifier extracted at stage 820. As discussed above, the virtual treatment kit represents an approved assemblage of medications and a treatment plan for administering the medications to the patient in order to treat the diagnosed medical condition.

At stage 840, at least part of the information from the virtual treatment kit may be provided. For example, the information from the virtual treatment kit may be presented, on a display of the system and/or in hard copy form, such as in a print out using a connected printer. This information may be used to assemble the medication in the virtual kit to be distributed to the patient.

At stage 850, occurrence information for a given medical condition may be determined based on at least the diagnostic identifier and a location at which a corresponding virtual treatment kit is dispensed, or a location at which a prescription request originated using location information included with the request. The determined occurrence information may indicate an outbreak of the given medical condition within an area approximate to the dispensing or prescription location. For example, if there is an unusual amount of a particular virtual treatment kit being dispensed or prescription requests having the same diagnostic identifier in an area, recognition of such condition may be used to create a warning signal indicating, for example, the occurrence of a disease outbreak.

The above-described aspects of the present disclosure may be advantageous for increasing the accuracy of delivering prescription therapeutics to patients. For example, by providing a therapeutic regimen based on a medical diagnosis rather than confusing medication abbreviations, fewer medication errors may occur due to an error in interpreting the abbreviations. In addition, the patients may receive effective treatments immediately upon diagnosis without the need of a referral to a specialist for their medical condition. Even further, by providing therapeutics based on the medical diagnosis rather than specific medications, the system may be further configured to determine a medical outbreak in a given area or community based on a location at which the virtual treatment kits associated with the medical diagnosis are being prescribed and/or dispensed.

Although the invention herein is described with reference to particular embodiments, it is to be understood that these embodiments are merely illustrative of the principles and applications of the present invention. It will also be understood that the provision of examples of the disclosure (as well as clauses phrased as “such as,” “e.g.”, “including” and the like) should not be interpreted as limiting the disclosure to the specific examples; rather, the examples are intended to illustrate only one of many possible embodiments. It is therefore understood that numerous modifications may be made to the illustrative embodiments and that other arrangements may be devised without departing from the spirit and scope of the present invention as defined by the appended claims.

1. A computer implemented method for prescribing a therapeutic regimen, comprising:
receiving, by one or more computing devices, prescription information for a patient, the prescription information including information representing a medical condition identified by a prescriber;
extracting, by the one or more computing devices, one or more identifiers based on the prescription information, the identifiers indicating a diagnosis associated with the medical condition; and
identifying, by the one or more computing devices, from virtual treatment kit information a virtual treatment kit having one or more updatable components from a database using at least one of the identifiers, each of the updatable components including component information representing at least one predetermined medication and a treatment plan for administering the predetermined medication for treating the identified medical condition.

2. The computer implemented method of claim 1, further comprising controlling the database for providing at least part of the component information from the virtual treatment kit.

3. The computer implemented method of claim 1, wherein component information comprises an individual dosage amount and quantity for the predetermined medication.

4. The computer implemented method of claim 1, further comprising generating the virtual treatment kit information to indicate at least one virtual treatment kit as the kit associated with a given diagnosis in the database.

5. The computer implemented method of claim 4, wherein the generating of the virtual treatment kit information is in accordance with approval information for the predetermined medication from an insurance provider.

6. The computer implemented method of claim 5, wherein the approval information is associated with information in the database indicating the virtual treatment kit.

7. The computer implemented method of claim 4, wherein the virtual treatment kit information is generated by substituting at least one component of the one or more updatable components of the virtual treatment kit with information regarding a different medication.

8. The computer implemented method of claim 7, wherein the virtual treatment kit information is generated by substituting at least one component of the one or more updatable components of the virtual treatment kit with information regarding a different treatment plan.

9. The computer implemented method of claim 1, further comprising determining occurrence information for a given medical condition based on at least the identifier in the database indicating a diagnosis for the given medical condition and a location at which the virtual treatment kit associated with the diagnosis is dispensed or prescribed, the determined occurrence information indicating a prevalence of the given medical condition within a given area approximate to the location such that an outbreak in the area can be detected.

10. A non-transitory computer readable medium storing instructions that, when executed by one or more processors, cause the one or more processors to perform a method for prescribing a therapeutic regimen, the method comprising:
receiving, by the one or more processors, prescription information for the patient, the prescription information including information representing a medical condition identified by a prescriber;
extracting, by the one or more processors, one or more identifiers based on the prescription information, the identifiers indicating a diagnosis associated with the medical condition; and
identifying, by the one or more processors, virtual kit information from a virtual treatment kit having one or more updatable components from a database using at least one of the identifiers, each of the updatable components include component information representing at least one predetermined medication and a treatment plan for administering the predetermined medication for treating the identified medical condition.

11. The non-transitory computer readable medium of claim 10, wherein the method further comprises providing at least part of the component information from the virtual treatment kit.

12. A system for prescribing a therapeutic regimen, comprising:
a memory storing a plurality of virtual treatment kits; and
one or more processors in communication with the memory, the one or more processors being configured to:
receive prescription information for a patient, the prescription information including information representing a medical condition diagnosed by a prescriber;
extract one or more identifiers based on the prescription information, the identifiers indicating a diagnosis associated with the medical condition; and
identify virtual treatment kit information from a virtual treatment kit having one or more updatable components from memory using at least one of the identifiers, each of the updatable components include component information representing at least one predetermined medication and a treatment plan for administering the predetermined medication for treating the identified medical condition.

13. The system of claim 12, wherein the processors are configured to control the database for providing at least part of the component information from the virtual treatment kit.

14. The system of claim 12, wherein component information comprises an individual dosage amount and quantity for the predetermined medication.

15. The system of claim 12, wherein the processors are configured to generate the virtual treatment kit information to indicate at least one virtual treatment kit in memory as the kit associated with a given diagnosis.

16. The system of claim 15, wherein to generate the virtual treatment kit information to indicate the at least one virtual treatment kit the processors are configured to receive approval information for the predetermined medication from an insurance provider associated with the patient.

17. The system of claim 16, wherein the generating virtual treatment kit information is in accordance with approval information associated with information in the database indicating the at least one virtual treatment kit.

18. The system of claim 15, wherein the processors are configured to generate the virtual treatment kit information by substituting at least one component of the one or more updatable components of the virtual treatment kit for information regarding a different medication.

19. The system of claim 18, wherein the processors are configured to generate the virtual treatment kit information by substituting at least one component of the one or more updatable components of the virtual treatment kit for information regarding a different treatment plan.

20. The system of claim 12, wherein the processors are configured to determine occurrence information for a given medical condition based on at least the identifier in the database indicating a diagnosis for the given medical condition and a location at which the virtual treatment kit associated with the diagnosis is dispensed or prescribed, the determined occurrence information indicating a prevalence of the given medical condition within a given area approximate to the location such that an outbreak in the area can be detected.
